(19) United States
(12) Patent Application Publication
(10) Pub. No.: US 2010/0003877 A1
(43) Pub. Date: Jan. 7, 2010

(54) Three-tier reflective nanofibrous structure

(75) Inventors: Jintu Fan, Kowloon (HK); Huijun Wu, Kowloon (HK)

Correspondence Address: The Hong Kong Polytechnic University, Suite 600, Mail Box # 119, 1800 Diagonal Road, Alexandria, VA, 22314, US

(73) Assignee: The Hong Kong Polytechnic University, Kowloon (HK)

(21) Appl. No.: 12/216,477

(22) Filed: Jul. 7, 2008

(51) Int. Cl. B32B 27/12; B29C 71/00

(52) U.S. Cl. 442/132; 427/532

(57) ABSTRACT

The present invention provides a three-tier reflective nanofibrous structure having a woven or nonwoven substrate, a polymeric nanofibers web on the substrate, and an infrared radiation reflection coating on the web. The present nanofibrous structure has good reflection to heat radiation in the near infrared, has good resistance to heat conduction, has good permeability to water vapor moisture, and is light weight. A method of fabricating both radiation relective and nanofibrous structure is also presented.

### BACKGROUND

Thermal insulation and cold protective materials are extensively used in various applications, such as building constructions, energy storage facilities, aircrafts as well as cold protective clothing for reducing the heat transfer between a medium and its environment. Among the various thermal insulation and cold protective materials, such as powder insulation, foam insulation, vacuum panels, fibrous insulation materials have the advantage in terms of high thermal insulation, light weight, good moisture permeability, and shock-absorbing ability, because of their extremely high porosity, generally 95% or above (Tseng and Kuo, Thermal radiative properties of phenolic foam insulation, Journal of Quantitative Spectroscopy & Radiative Transfer, 72, 349-359 (2002)). Within the fibrous insulation materials, heat transfer mechanisms mainly involve conduction and thermal radiation (Farnworth, Mechanisms of heat flow through clothing insulation, Textile Research Journal, 53(12), 717-725 (1983)). A significant amount of work, for example Farnworth (1983), Wu et al. (2007), Du et al. (2007), has shown that radiative flux can be a significant contributor to the total heat transfer within these highly porous fibrous insulations. To reduce radiative heat flux, one may increase fiber fractional volume (or reducing the porosity) of the fibrous insulation, see Farnworth (1983) and Wu et al. (2007), or introducing thin dense films as interlayers (Wu and Fan, Measurement of radiative thermal properties of thin polymer films by FTIR, Polymer Testing, 27: 122-128 (2008)), however this would lead to an increase of conductive heat flux and reduction of moisture permeability. In applications where moisture transmission takes place in the fibrous insulation, for example, cold protective clothing or sleeping bags, reduction of moisture permeability will induce increased moisture accumulation and condensation within the fibrous insulation and consequently reduce effectiveness in thermal insulation. It is therefore a challenge to reduce the radiative heat loss without increasing conductive heat loss and blocking the moisture transmission.

Developing fine fibers and metallic or metallized fibers are found to be the most efficient ways to reduce radiative heat transfer by increasing their surface area to volume ratio or improving their absorption and scatting to thermal radiation. Superfine fibrous films, when used as interlayers in the fibrous insulation, have great potential in blocking the radiative heat loss without increasing conductive heat loss and reducing the moisture permeability (Wu et al., Thermal radiative properties of electrospun superfine fibrous PVA films, Materials Letters, 62, 828-831 (2008)). This is because the resistance to radiative heat transfer is strongly related to the total surface area and surface properties of fibers. The high surface-to-volume ratio of superfine fibers can increase the absorption efficiency to thermal radiation and consequently improve the blocking of heat transfer by radiation. The blocking thermal radiation can be further improved by coating a reflective layer on the fiber surface and hence increasing the radiation extinction coefficient. Furthermore, because of the high porosity and very fine fiber diameter, such material was also found to be highly permeable to moisture transmission (Gibson et al., Transport properties of porous membranes based on electrospun nanofibers, Colloids and Surfaces A: Physicochemical and Engineering Aspects, 187-188, 469-481 (2001)). Nevertheless, the potential problem of the superfine fibers is their weak strength if used alone. This invention is therefore envisaged to fabricate three-tier reflective nanofibrous structures for use as interlayers in the thermal insulation systems such as cold protective clothing and sleeping bags.

Although several radiation reflection coatings with aluminum (Al), silver (Ag), or gold (Au) on general woven or nonwoven substrate have been reported, the coating layer is generally dozens of micrometers thick so the weight of the coating is relatively heavy. If such existing coating fabrics are used as interlayers in insulation systems, there will be substantial unwanted weight increase of over 20%. As a result, the weight of the cold protective system may be noticeably increased after coating with radiation reflection materials, which is unwanted for most cold protective systems especially for clothing, sleeping bags, and aircrafts. Moreover, the thick coating with metals will also significantly reduce the permeability to water vapor. Condensation of water vapor will take place when they are used as cold protective clothing under extremely cold environment, and this will significantly increase the heat loss through the clothing.

It is an object of the present invention to overcome the disadvantages and problems in the prior art.

### DESCRIPTION

The present invention provides a three-tier reflective nanofibrous structure having a woven or nonwoven substrate, a polymeric nanofibers web on the substrate, and an infrared radiation reflection coating on the web. The present nanofibrous structure has good reflection to heat radiation in the near infrared, has good resistance to heat conduction, has good permeability to water vapor moisture, and is light weight. A method of fabricating both radiation rejective and nanofibrous structure is also presented.

These and other features, aspects, and advantages of the apparatus and methods of the present invention will become better understood from the following description, appended claims, and accompanying drawings where:

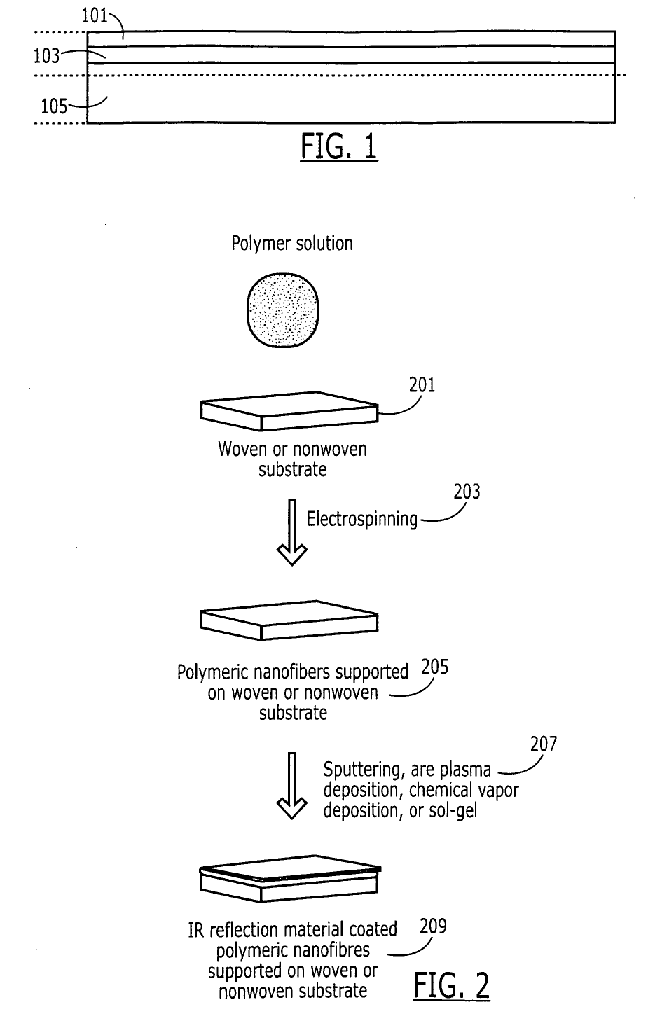

FIG. 1 shows an embodiment of a three-tier reflective nanofibrous structure of the present invention;

FIG. 2 shows a suitable method of making the present structure;

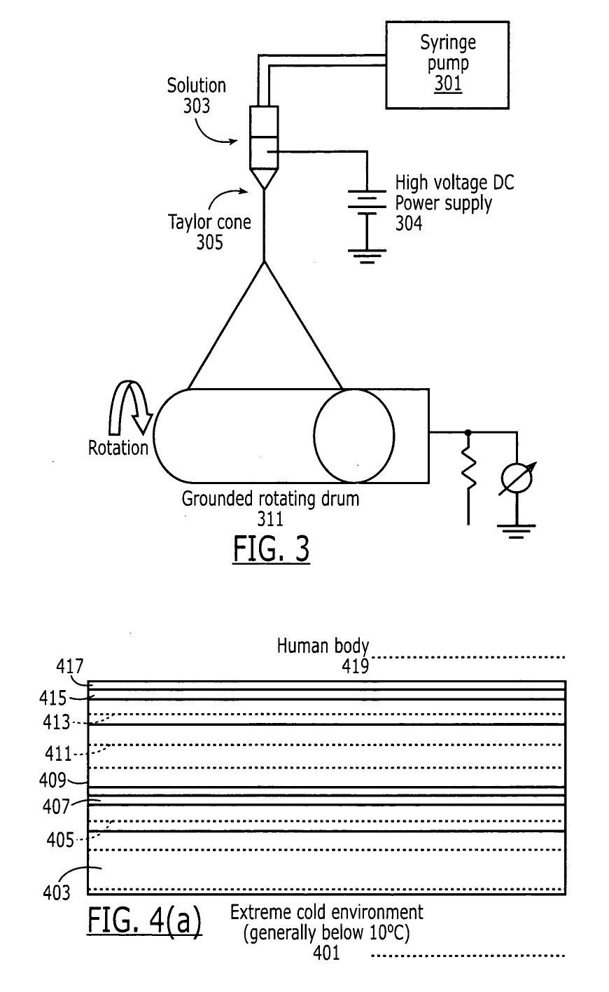

FIG. 3 exhibits an electrospinning process suitable for forming the nanofibrous structure;

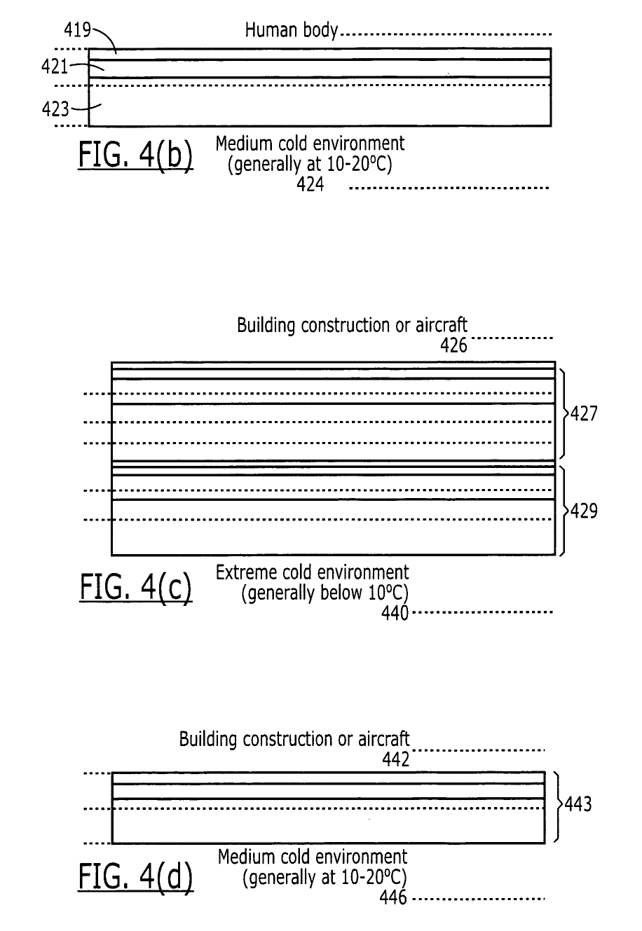

FIG. 4(a-d) shows various used for the present three-tier structure;

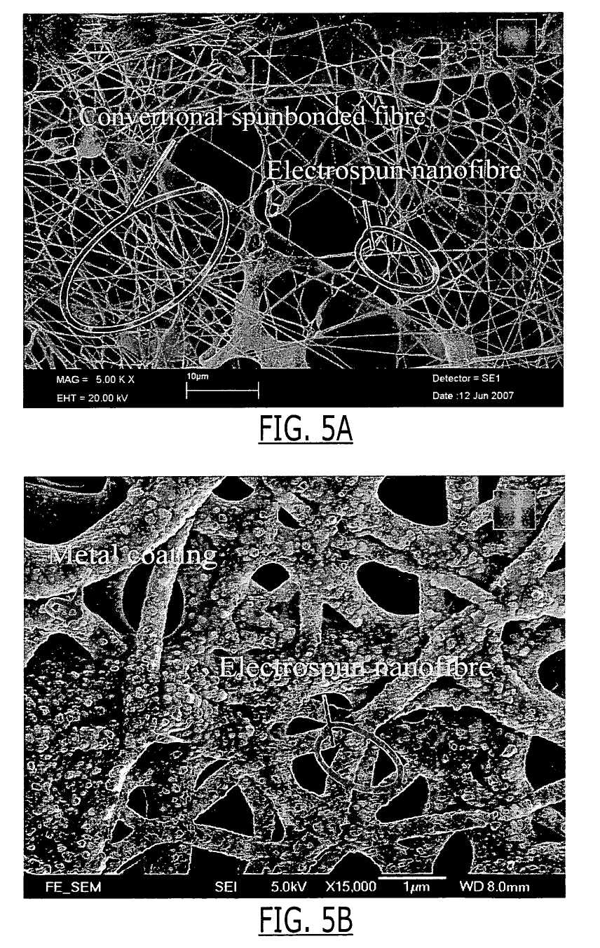

FIG. 5(a-b) show field-emission SEM images of the spunbonded PP web supported electrospun PVA nanofibers and the Al coated PVA nanofibers;

FIG. 5(c) is a TEM image of the cross-sectional specimen of the Al coated PVA nanofibers;

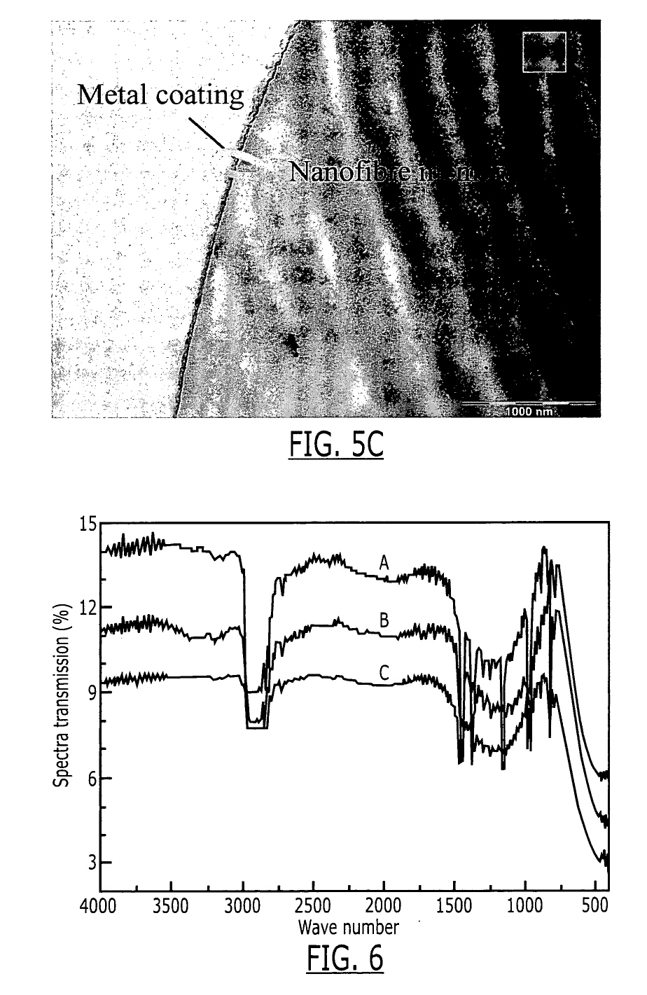

FIG. 6 shows three IR transmittance spectra obtained through the three types of PP web samples;

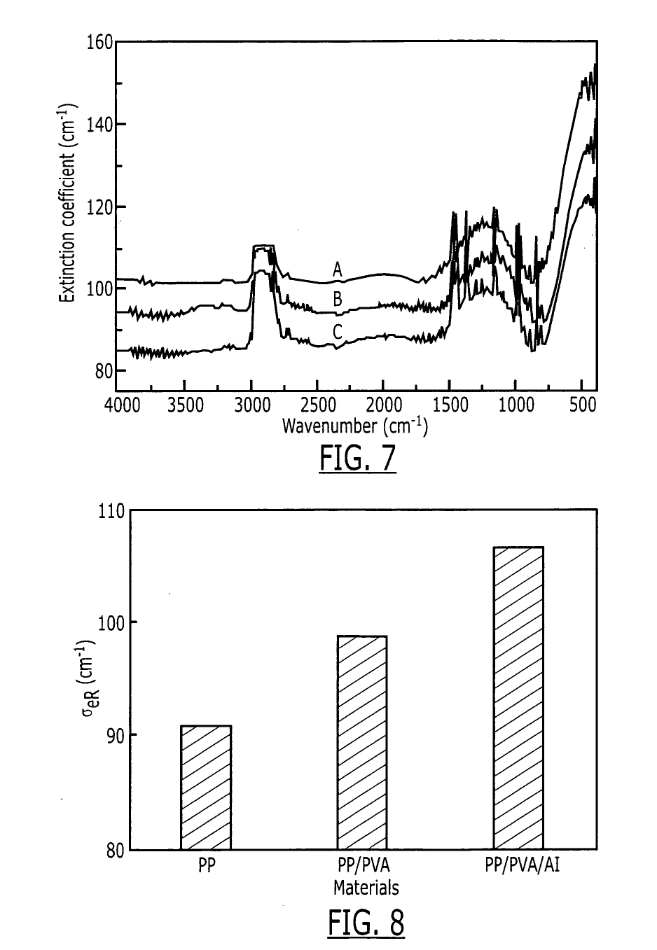

FIG. 7 shows the spectral extinction for three PP web samples;

FIG. 8 is apparent Rosseland extinction coefficients of thin film samples.

The following description of certain exemplary embodiment(s) is merely exemplary in nature and is in no way intended to limit the invention, its application, or uses.

Now, to FIGS. 1-8,

FIG. 1 is an embodiment of a three-tier reflective nanofibrous structure of the present invention, having a woven or nonwoven substrate 105, a polymeric nanofibers web on the strengthened substrate 103, and an infrared radiation reflection coating on the polymeric nanofibers web 103.

The woven or nonwoven substrate 105 can be selected from the group consisting of wook, silk, gunny, polyester, nylon, polypropylene, polyethylene, polystyrene, polyether, polyamide, polyimide, polyacrylonitrile, polyvinylchloride, and acrylic polymers.

As will be discussed later, various polymeric materials including synthetic and natural polymers may be used to form the nanofibers web 103 on a woven or nonwoven substrate by electrospinning. While the amount of the IR reflection material 101 is very small, it has a noticeable improvement on radiation reflection since the supporting nanofibers provide a great surface area to volume ratio. As a result, the coating of IR radiation reflection layer increases the thermal radiation extinction in IR and consequently improves the thermal insulation performance.

FIG. 2 is an embodiment of making the nanofibrous structure of the present invention. Firstly, a stable polymer solution and woven or nonwoven substrate are prepared 201. Electrospinning polymeric nanofibers on the substrate is then performed 203, resulting in a polymeric nanofiber/woven or nonwoven substrate 205. Fabrication of IR radiation reflection layer coated polymeric nanofibers on woven or nonwoven substrate 207, resulting in the structure 209 of the present invention.

Suitable polymeric materials to be applied to the substrate can include synthetic polymers such as ethenic polymers and condensation polymers. Ethenic polymers are formed by polymerizing monomers containing the carbon to carbon double bond group. Important ethenic polymers for electrospinning nanofibers include polyethylene, vinyl chloride polymers and copolymers, and polystyrene. For condensation polymers, the monomers have at least two functional groups such as alcohol, amine, or carboxylic acid gropu instead of a carbon-carbon double bond group. Various condensation polymers, such as Nylon, polyacrylic acid, polyacrylonitrile, polycarbonate, poly(etherimide), poly(ethylene terephthalate), poly(urethane), poly (vinyl alcohol) may be used to form nanofibers on a woven or nonwoven substrate. For natural polymers, proteins, and polysaccharides are most polymers to be electrospun for forming nanofibers. Since these natural polymers have a distinct advantage over synthetic materials such as degradable by naturally occurring enzymes, which is advantageous for safe post-disposal of the fibrous insulation.

As will be discussed later, electrospinning is an approach using electrostatic forces to produce fine fiber. In the present invention, an electric field is generated between a charged polymer fluid and a collection screen. As the power is increased, the charged polymer solution is attracted to the fiber collection. Once the voltage reaches a critical value, the charge overcomes the surface tension of the polymer cone and superfine fibers are produced. As the charged fibers are sprayed, the solvent quickly evaporates and the fibers are accumulated randomly or aligned on the surface of the fiber collector.

The IR radiation reflection layer may be deposited onto the polymeric nanofibers with metal such as aluminum (Al), silver (Ag), and gold (Au), metal oxide such as aluminum oxide (Al₂O₃), titanium dioxide (TiO₂), zinc oxide (ZnO), and cerium dioxide (CeO₂), and metal oxides doped with a dopant selected from the group consisting of fluorine, boron, aluminum, gallium, thallium, copper, and iron. The coating of the IR reflection materials may be formed onto the polymeric nanofibers by sputtering, arc plasma deposition, chemical vapor deposition, and sol-gel method.

FIG. 3 is a schematic of the electrospinning process suitable for the present invention. Electrospinning is a approach using electrostatic forces to produce fine fibers. The advantages of the electrospinning process are simplicity, easy adaptability, and industrial feasibility. The machine used for electrospinning includes a high voltage electric source 304 with positive or negative polarity, a syringe pump 301 with cappillaries or tubes to carry the solution 303 from the syringe 305 to the spinneret 311.

FIG. 4(a-d) shows various uses for the present three-tier structure.

As shown in FIG. 4(a), the structure is usable as interlayers to be added into highly porous battings in cold protective clothing and sleeping bags under extreme cold climates so as to increase heat resistance to radiation without unacceptable weight increase or water vapor permeability damage. The number of structures can be selected in the range of 1-7 for application in cold protective clothing or sleeping bags. As shown in 4(a), 2 structures are used, with one 403/405/407 being placed at the bottom and another 411/413/415 being placed at the top. Additional layers 417/409 are used as adhesive or to add comfort between a user 419 and the layers. A structure such as this is suitable for extremely cold temperatures 401 (below 10° C.).

FIG. 4(b) shows a single structure 419/421/423 used directly to form cold protective clothing or sleeping bags under medium cold environments (between 10° C. to 20° C.) 424.

FIG. 4(c) shows that the three-tier reflective nanofibrous structure may also be usable in other protective systems, such as building constructions and aircrafts 426, in a certain number of three-tier structure 427/429 added as interlayers. Such a structure is suitable in extreme cold environments (below 10° C.) 440. FIG. 4(d) shows the three-tier reflective nanofibrous structure 443 wherein the three-tier structure is directly used as thermal insualtion system. Such a structure is suitable for use in medium cold environments (generally 10 to 20° C.) 446.

In both FIG. 4(c) and FIG. 4(d), the thermal insulating systems also benefit from being coated with a nanofiber web and IR radiation reflection layers to reduce the heat loss by radiation and consequently improve the cold protective performance.

In the above embodiments, the thickness of the woven or nonwoven substrate may be selected in the range of from about 0.1 to about 10 mm in terms of its specialized application requirement and the electrospinning process conditions. The thickness, diameter, and porosity of the nanofibers web may be controlled to support the IR radiation reflection coating by altering the electrospinning process parameters such as electrostatic pressure distance between spinneret and substrate, and flow rate of polymer solution. The diameters of the electrospun nanofibers from most polymers are typically in the range 100 to 1000 nm. The thickness of the IR radiation reflection layer may be selected to control both the percent of the IR radiation reflection under particular application temperature and the weight increase of the thermal insulation through coating. Generally, the thickness in the range of 10 nm and 100 nm are suitable for efficiently reflecting radiation in IR without unacceptable weight increase.

### EXAMPLE

A three-tier reflective nanofibrous structure comprising PP web/PVA nanofibers/AL coating is made in accordance with the present invention. At first, the PVA nanofibers are electrospun onto the spunbonded PP web of the thickness about 0.23 mm by using electrospinning technique to improve the strength of the nanofiber membrane; then the electrospun nanofibers was coated with AL by using sputtering deposition technique to extinct thermal radiation in advance.

FIGS. 5a and 5b show the field-emission SEM images of the spundbonded PP web supported electrospun PVA nanofibers and the AL coated PVA nanofibers, respectively. As shown in FIG. 5a the electrospun PVA fibers are randomly deposited on the spunbonded PP substrate. The average diameter of the substrate polypropylene fibers is about 22 μm while the electrospun PVA fibers have diameters five times smaller. From FIG. 5b, the average diameter of the electrospun PVA fibers was determined to be approximately 430 nm. A TEM image of the cross sectional specimen of the AL coated PVA nanofibers is shown in FIG. 5c. The electrospun PVA fibers can be seen on the right side of theimage and the black grey area in the image corresponds to the metal coating. The AL coating layer is estimated to be approximately 37 nm in thickness, much smaller than the supported PP web, indicating that there is no significant increase in weight or denisty of the functional fibrous assembly.

FIG. 6 illustrates three IR transmittance spectra obtained through the three types of PP web samples with or without electrospun nanofibers or metail coating. According Beer's Law, the spectral extinction coefficient to IR of thin films (σ_{e,λ}) is obtained from the transmittance spectra (τ_{λ}) and the thickness of thin films (L) as follows:

$${σ}_{e , λ} = - \frac{ln ( τλ )}{L}$$

The spectral extinction of the three specimens is shown in FIG. 7. The spectral extinction coefficient of the PP webs is noticeably increased by adding electrospun PVA nanofibers and further increased by coating the nanofibers with AL. A comparison between FIGS. 7b and 7c indicates that a further noticeable improvement of thermal radiation extinction can be obtained by coating aluminum onto the PP supported PVA nanofibers, although the aluminum coating has much smaller thickness compared to the control PP web. It is because even little metal coated fibers can efficiently scatter and absorb radiation due to the fact that the coated fibers act like little antennae for their enhanced electrical conductivity.

In order to quantitatively compare the extinction coefficients of the three samples with or without nanofiber or aluminum coating, an apparent Rosseland mean extinction coefficient (σ_{e,R}) was introduced. The apparent Rosseland mean extinction is determined by using the Rosseland approximation:

$$\frac{1}{{σ}_{e , R}} = \int \frac{1}{{σ}_{e , λ}} \frac{\partial {e}_{b , λ}}{\partial {e}_{b}}$$

where e_{b,λ} is the spectral black body emissive power,and T is the medium temperature.

The determined results of the apparent Rosseland mean extinction coefficients for the three different samples are illustrated in FIG. 8. The Rosseland mean extinction coefficient of the uncoated PP web was 90.6 cm⁻¹ compared to 98.7 and 106.6cm-1 for the PP web/PVA nanofibers and PP web/PVA nanofibers/AL coating three-tier structure. A significant increase of approximately 18% without noticeable weight increase, in the apparent Rosseland mean extinction coefficient was achieved for the present invention PP web/PVA nanofiber/AL coating three-tier structure compared to the uncoated PP webs. These results indicate that using coated nanofibers may provide an effective means to improve thermal radiation extinction in thermal insulation systems without a noticeable weight gain. Better extinction coefficients can be expected by optimizing the diameters of supporting polymer fibers and electrospun nanofibers as well as the thickness of the coated aluminum.

The water vapor transmission rates of the three samples with or without nanofibers or metal coating are listed in Table 1 using the water vapor transmission dish method according to the British Standard BS7209 (1990). The PP/PVA/AL three-tier reflective structure presented in this invention has very similar water vapor transmission rate like the uncoated the PP web. This behaviour is expected because the metal coating was deposited on the nanofibers rather than directly on the PP substrate so that the porous structure of the system was unaffected. High moisture permeability is advantageous for applications in cold weather clothing, sleeping bags, building constructions, and aircraft because the accumulation of water vapor accumulation will result in great reduction of the thermal insulation performance. Concerning the significant improvement in extinction thermal radiation but the little increase in weight gain and water vapor block, this present invention provides a three-tier reflective nanofibrous structure may be expected to be widely applied high performance thermal resistant but moisture permeable systems under extremely or medium cold environments.

TABLE 1
Water Vapor Transmission Rate

| | Water Vapor Transmission |
|---|---|
| Sample | (g H₂0/m²/hr) |
| PP web | 33.24 |
| PP web/PVA nanofibers | 35.27 |
| PP web/PVA | 33.73 |
| Nanofibers/Aluminum Coating | |

Having described embodiments of the present system with reference to the accompanying drawings, it is to be understood that the present system is not limited to the precise embodiments, and that various changes and modifications may be effected therein by one having ordinary skill in the art without departing from the scope or spirit as defined in the appended claims.

In interpreting the appended claims, it should be understood that:

a) the word “comprising” does not exclude the presence of other elements or acts than those listed in the given claim;

b) the word “a” or “an” preceding an element does not exclude the presence of a plurality of such elements;

c) any reference signs in the claims do not limit their scope;

d) any of the disclosed devices or portions thereof may be combined together or separated into further portions unless specifically stated otherwise; and

e) no specific sequence of acts or steps is intended to be required unless specifically indicated.

1. A three-tier reflective nanofibrous structure, comprised of:
a substrate selected from the group consisting of woven substrate and nonwoven substrate;
a nanofiber web; and
and an infrared radiation reflecting coating.

2. The three-tier reflective nanofibrous structure of claim 1, wherein said substrate can be selected from the group consisting of wool, silk, gunny, polyester, nylon, polypropylene, polyethylene, polystyrene, polyether, polyamide, polyimide, polyacrylonitrile, polyvinylchloride, and acrylic polymers.

3. The three-tier reflective nanofibrous structure of claim 1, wherein said infrared radiation reflecting coating can be selected from the group consisting of aluminum, silver, gold, aluminum oxide, titanium dioxide, zinc oxide, cerium dioxide, and metal oxides doped with a dopant selected from the group consisting of fluorine, boron, aluminum, gallium, thallium, copper, and iron.

4. An insulating product suitable for cold environments comprised of a manufactured product and between 1 to 7 layers of a three-tier reflective nanofibrous structure inserted between the inside and outside layers of said textile, wherein said three-tier reflective nanofibrous structure is made of a substrate selected from the group consisting of woven substrate and nonwoven substrate, a nanofiber web, and an infrared radiation reflecting coating.

5. The cold protective clothing in claim 4, wherein said substrate of said structure can be selected from the group consisting of wool, silk, gunny, polyester, nylon, polypropylene, polyethylene, polystyrene, polyether, polyamide, polyimide, polyacrylonitrile, polyvinylchloride, and acrylic polymers.

6. The cold protective clothing in claim 4, wherein said infrared radiation reflecting coating of said structure can be selected from the group consisting of aluminum, silver, gold, aluminum oxide, titanium dioxide, zinc oxide, cerium dioxide, and metal oxides doped with a dopant selected from the group consisting of fluorine, boron, aluminum, gallium, thallium, copper, and iron.

7. The cold protective clothing in claim 4, wherein said manufactured product is selected from the group consisting of sleeping bags, coats, hats, gloves, sweaters, building insulation, and aircraft.

8. The cold protective clothing in claim 4, wherein between 1 to 3 layers of said structure are used.

9. A method of making a three-tier reflective nanofibrous structure, comprising the steps of:
preparing a polymer solution and a substrate selected from the group consisting of a woven substrate and nonwoven substate;
electrospinning polymeric nanofibers on said substrate; and
depositing an IR radiation reflecting layer on said substrate.

10. The method of making a three-tier reflective nanofibrous structure of claim 9, wherein preparing said polymer solution comprises making a polymer solution selected from the group consisting of polyethylene, vinyl chloride polymers, polystyrene, Nylon, polyacrylic acid, polyacrylonitrile, polycarbonate, poly(etherimide), poly(ethylene terephthalate), poly(urethane), poly(vinyl alcohol), proteins, and polysaccharides.

11. The method of making a three-tier reflective nanofibrous structure of claim 9, wherein depositing said IR radiation reflecting layer can be selected from the group consisting of sputtering, arc plasma deposition, chemical vapor deposition, and sol-gel method.

12. The method of making a three-tier reflective nanofibrous structure of claim 9, wherein electrospinning comprises utilizing a machine possessing a high voltage electric source with positive or negative polarity, a syringe pump with capillaries, a syringe, and a spinneret.
